(19) United States
(12) Patent Application Publication
(10) Pub. No.: US 2024/0013937 A1
(43) Pub. Date: Jan. 11, 2024

(54) IN-CORE PRINTED CIRCUIT HEAT EXCHANGER

(71) Applicant: The Texas A&M University System, College Station, YX (US)

(72) Inventors: Mark Kimber, College Station, TX (US); Kraig Farrar, Bryan, TX (US)

(21) Appl. No.: 18/346,632

(22) Filed: Jul. 3, 2023

Related U.S. Application Data
(60) Provisional application No. 63/358,812, filed on Jul. 6, 2022.
(60) Provisional application No. 63/387,183, filed on Dec. 13, 2022.

(51) Int. Cl. G21C 1/32; G21C 3/54; G21C 15/24

(52) U.S. Cl. CPC G21C 1/32; G21C 3/54; G21C 15/24

(57) ABSTRACT

In multiple embodiments, a molten salt reactor system may include a heat exchanger within a reactor vessel that also acts as the reactor core (e.g., a shell-and-tube heat exchanger, or a printed circuit heat exchanger), wherein the heat exchanger includes the moderator material so that fission reactions within the nuclear molten fuel salt occur within the heat exchanger. In many embodiments, the in-core heat exchanger of the disclosed molten salt reactor system may include a coolant side and a molten fuel salt side, and the coolant may be a liquid (e.g., non-fissionable molten salt) or a gas (e.g., carbon dioxide). Heat generated from the fission reactions is transferred from the molten fuel salt side to the coolant side. In some embodiments, when the coolant is a gas, the coolant may be utilized with a turbine for power production.

### CROSS-REFERENCE TO RELATED APPLICATIONS

The present application claims priority under 35 U.S.C. § 119 to U.S. Provisional Application No. 63/358,812, entitled “IN-CORE PRINTED CIRCUIT HEAT EXCHANGE IN MOLTEN SALT REACTORS,” filed on Jul. 6, 2022, and U.S. Provisional Application No. 63/387,183, entitled “IN-CORE HEAT EXCHANGER WITH GAS COOLANT IN MOLTEN SALT REACTORS,” filed on Dec. 13, 2022, in which the entirety of both are incorporated by reference herein.

### TECHNICAL FIELD

The described examples relate generally to systems, devices, and techniques for molten salt reactor systems, and more specifically, to heat exchangers within molten salt reactor systems.

### BACKGROUND

Nuclear molten salt reactor systems generally include a primary loop wherein molten fuel salt with nuclear fuel (e.g., uranium tetrafluoride) flows in a closed-loop and undergoes a fission reaction that generates heat inside a reactor core, and then is pumped out of the core to an external heat exchanger in which the generated heat is transferred to one or more coolants. The one or more coolants flows in a secondary loop of the molten salt reactor system. Typically, the one or more coolants are also a molten salt that does not include nuclear fuel within the salt. The coolant salt and systems needed to maintain the coolant salt are expensive and, in some cases, the coolant salt may need to be changed periodically, such as due to the buildup of corrosion products over time. Further, coolant salt cannot be used to generate power (e.g., flow through a turbine), and so the coolant salt will have to exchange heat with a different fluid in one or more additional heat exchangers that are on separate additional loops that require additional equipment to maintain the additional loops, so that the system can generate electricity. The use of multiple heat exchangers results in less efficient energy production because energy is lost to the piping and other parts of the system as the coolant salt and other materials flow.

Additionally, in molten salt reactors that include heat exchangers outside of the core of the reactor, the outlet temperature of the molten salt fuel from the reactor going to the heat exchanger (the “hot leg”) can be significantly higher than the temperature of the molten salt fuel that is coming out of the heat exchanger and going back into the reactor (the “cold leg”). This temperature difference, which can sometimes be up to one hundred degrees Celsius, can cause hot leg corrosion and cold leg deposition issues, which may occur in molten salt reactor systems having heat exchangers outside the core of the reactor.

Therefore, there is a long-felt, but unresolved need for an improved heat exchanger in a molten salt reactor core region that offers high heat transfer rates through an increased surface area of the heat exchanger, and additionally a need to operate an in-core heat exchanger with certain coolants (including gas coolants) that can increase power generation efficiency, support passive cooling, and reduce costs of a molten salt reactor system.

### SUMMARY

In one example, an in-core printed circuit heat exchanger is disclosed. The heat exchanger includes a heat exchange array formed from a moderator material that defines a plurality of fuel channels and a plurality of coolant channels therethrough. The plurality of coolant channels are fluidically isolated from the plurality of fuel channels. The heat exchanger further includes a pair of fuel distributors coupled with opposing ends of the plurality of fuel channels that are configured to provide the fuel to each of the plurality of fuel channels, and to correspondingly collect the fuel from each of the plurality of fuel channels and combine the fuel into a single fuel exit flow. The heat exchanger further includes a pair of coolant distributors coupled with opposing ends of the plurality of coolant channels that are configured to provide the coolant to each of the plurality of coolant channels, and to correspondingly collect the coolant from each of the plurality of coolant channels and combine the coolant into a single coolant exit flow. The in-core printed circuit heat exchanger is configured to permit the fuel to undergo fission reactions therein.

In another example, the plurality of fuel channels and the plurality of coolant channels may cooperate to establish: (i) a cross flow of the fuel relative to the coolant, (ii) a parallel flow of the fuel relative to the coolant, or (iii) an opposing flow of the fuel relative to the coolant.

In another example, the moderator material may define the plurality of fuel channels across a first stack of heat exchange layers, and the plurality of coolant channels across a second stack of heat exchange layers interposed with the layers of the first stack of heat exchange layers.

In another example, the first stack of heat exchange layers and the second stack of heat exchange layers are, collectively, portions of an integrally constructed, one-piece structure.

In another example, channels of one or both of the plurality of fuel channels or the plurality of coolant channels establishes a tortuous flow path through the moderator material.

In another example, channels of one or both of the plurality of fuel channels or the plurality of coolant channels includes a series of baffle structures to promote the tortuous flow path.

In another example, the pair of fuel distributors and the pair of coolant distributors include or are otherwise associated with a neutron reflector material. For example, the neutron reflector material may, in some examples, surround part or all of any of the pair of fuel distributors or the pair of coolant distributors.

In another example, the plurality of coolant channels may be configured to receive a high temperature coolant comprising a supercritical CO₂, a helium, a molten salt, or a liquid metal.

In another example, the heat exchange array, the pair of fuel distributors, and the pair of coolant distributors may be arrangeable within a reactor vessel of an integral nuclear reactor system that permits the closed loop circulation of fuel therein. Further, the pair of fuel distributors each include an opening fluidly coupled with the fuel of the integral nuclear reactor. Further, the pair of coolant distributors may be each coupled with a corresponding pair of coolant pipe legs that define a cold leg of the coolant flowing into a first distributor of the pair of coolant distributors, and a hot leg of the coolant flowing from a second distributor of the pair of coolant distributors. Further, the pair of coolant distributors and the pair of coolant pipe legs maintain a fluidic isolation of the coolant from the fuel of the reactor vessel.

In another example, a molten salt reactor system is disclosed. The system includes an in-core printed circuit heat exchanger having a heat exchange array formed from a moderator material and defining a plurality of fuel channels and a plurality of coolant channels therethrough, the plurality of coolant channels being fluidically isolated from the plurality of fuel channels. The system further includes a coolant circulation system configured to provide a continuous circulation of a reduced temperature coolant to each of the plurality of coolant channels, and to receive a continuous circulation of an elevated temperature coolant from each of the plurality coolant channels. The system further includes a fuel circulation system configured to provide a continuous circulation of an elevated temperature fuel to each of the plurality of fuel channels, and to receive a continuous circulation of a reduced temperature fuel from each of the plurality of fuel channels. Further, the in-core printed circuit heat exchanger is configured to permit the fuel to undergo fission reactions therein, and to transfer heat from the elevated temperature fuel to the reduced temperature coolant via the moderator material.

In another example, the coolant circulation system includes a coolant system heat exchanger configured to transition the coolant from the elevated temperature coolant to the reduced temperature coolant for continuous circulation with the plurality of coolant channels of the in-core printed circuit heat exchanger. Further, the fuel circulation system may include a circulation driver configured to continuously provide fuel to the plurality of fuel channels.

In another example, the coolant includes a gas. Further, the coolant circulation system may include a turbine and a compressor arranged along a circulation path of the coolant with the plurality of coolant channels and the coolant system heat exchanger.

In another example, the turbine may be configured to perform work from the elevated temperature coolant, said work being used to drive the compressor. Further, the compressor may be configured to maintain a pressure of the coolant along the circulation path on being driven by the turbine. Further, the coolant system heat exchanger may be configured to reduce a temperature of the coolant exiting the turbine prior to said coolant being recirculated along the circulation path to the compressor and plurality of coolant channels of the in-core printed circuit heat exchanger.

In another example, the molten salt reactor system may include a reactor vessel for the closed loop circulation of fuel therein. Further, the in-core printed circuit heat exchanger may be arranged substantially within the reactor vessel with the plurality of fuel channels arranged along a circulation path of the fuel within the reactor vessel. Further, the in-core printed circuit heat exchanger may include a pair of coolant pipe legs that define a cold leg of the coolant for flowing the coolant into each channel of the plurality of coolant channels, and hot leg of the coolant for flowing the coolant from each channel of the plurality of coolant channels. Further, the heat exchanger array may cooperate with the pair of coolant pipe legs and the reactor vessel to maintain a fluidic isolation of the coolant from the fuel of the reactor vessel.

In another example, the in-core printed circuit heat exchanger may be one of a plurality of in-core printed circuit heat exchangers. In this regard, each plurality of coolant channels of the plurality of in-core printed circuit heat exchangers may be fluidically coupled with the coolant circulation system.

In another example, a method of removing heat from a molten salt reactor system. The method includes circulating a coolant through a plurality of coolant channels formed through a moderator material. The method further includes circulating a fuel through a plurality of fuel channels formed through the moderator material, the plurality of fuel channels being fluidically isolated from the plurality of coolant channels. The method further includes transferring heat from the fuel of the plurality of fuel channels to the coolant of the plurality of coolant channels via the moderator material. The fuel undergoes fission reactions within the plurality of fuel channels.

In another example, circulating the coolant may include circulating the coolant along a continuous circulation path including a turbine, a coolant system heat exchanger, and a compressor.

In another example, the method may further include performing work, by the turbine, using an elevated temperature form of the coolant. The method may further include driving the compressor and generating electricity with the work performed by the turbine. The method may further include maintaining, using the compressor, a pressure of the coolant along the circulation path of the coolant.

In another example, the method may further include removing, using the coolant system heat exchanger, heat from the coolant prior to the coolant entering the compressor.

In another example, the method may further include circulating the fuel along a circulation path of the fuel that is fully contained with a reactor vessel of an integral nuclear reactor system

In addition to the example aspects described above, further aspects and examples will become apparent by reference to the drawings and by study of the following description.

### BRIEF DESCRIPTION OF THE DRAWINGS

FIG. 1A depicts a schematic representation of an example molten salt reactor system.

FIG. 1B depicts a schematic representation of another example molten salt reactor system.

FIG. 2 depicts a schematic representation of another example molten salt reactor system, including a gas coolant.

FIG. 3A depicts a schematic representation of another example molten salt reactor system.

FIG. 3B depicts a schematic representation of another example molten salt reactor system.

FIG. 3C depicts a schematic representation of another example molten salt reactor system.

FIG. 4 depicts an example in-core printed circuit heat exchanger.

FIG. 5 depicts an exploded view of the in-core printed circuit heat exchanger of FIG. 4.

FIG. 6 depicts an example heat exchange array of the in-core printed circuit heat exchanger of FIG. 6.

FIG. 7A depicts a distributor of the in-core printed circuit heat exchanger of FIG. 4

FIG. 7B depicts a cross-sectional view of the distributor of FIG. 7A, taken along line 7B-7B of FIG. 7A.

FIG. 8A depicts an example flow channel of an heat exchange layer of a heat exchange array of an in-core printed circuit heat exchanger.

FIG. 8B depicts another example flow channel of an heat exchange layer of a heat exchange array of an in-core printed circuit heat exchanger.

FIG. 9A depicts another example flow channel of an heat exchange layer of a heat exchange array of an in-core printed circuit heat exchanger.

FIG. 9B depicts another example flow channel of an heat exchange layer of a heat exchange array of an in-core printed circuit heat exchanger.

FIG. 10A depicts an example heat exchange layer of a heat exchange array of an in-core printed circuit heat exchanger.

FIG. 10B depicts an example adjacent heat exchange layer of the heat exchanger layer of FIG. 10A.

FIG. 11 depicts an example gas coolant loop of the present disclosure.

FIG. 12 depicts a chart including a salt mass flow rate plotted over time for a shutdown event.

FIG. 13 depicts a chart including temperature plotted over time for a shutdown event.

FIG. 14 depicts a chart including a fission power rate plotted over time for a shutdown event.

FIG. 15 depicts a chart including mass flow rate of CO2 plotted over time for a shutdown event.

FIG. 16 depicts a chart including K effective plotted over time for a shutdown event.

FIG. 17A depicts an example system including multiple in-core printed circuit heat exchangers used with multiple associated integral nuclear reactors.

FIG. 17B depicts another example system including multiple in-core printed circuit heat exchangers used with multiple loop-type nuclear reactor.

FIG. 18 depicts a flow diagram of an example method of removing heat from a molten salt reactor system.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes sample systems, methods, and apparatuses that embody various elements of the present disclosure. However, it should be understood that the described disclosure may be practiced in a variety of forms in addition to those described herein.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

The following disclosure relates generally to systems, devices, and techniques for in-core heat exchangers within molten salt reactor systems. For example, in various embodiments, a molten salt reactor system may generally include a molten fuel salt loop and a coolant loop (also referred to herein as a “secondary loop”). In one or more embodiments, the molten fuel salt loop may include a molten fuel salt that includes nuclear, fissionable material (e.g., dissolved uranium fluoride), and the coolant loop includes a coolant. The primary loop may also include a reactor core which includes a moderator material that assists in activating the nuclear reaction within the molten fuel salt, a fuel pump that pumps the fuel salt from an exit of the reactor core to an entrance of the reactor core, and a heat exchanger to transfer heat from the molten fuel salt in the molten fuel salt loop to the coolant in the coolant loop. In conventional molten salt reactor systems, the coolant is typically also a molten salt without nuclear materials, and that coolant flows through a secondary heat exchanger to transfer heat to a second coolant in a tertiary loop, which requires additional systems and devices to monitor and support said coolant and tertiary loops. These systems are inefficient and costly, as the multiple heat transfers across multiple heat exchangers results in more heat lost to the systems, and the additional flow through additional piping also results in heat loss. Thus, these conventional systems do not produce power efficiently, and the infrastructure to support the coolant loop with a molten salt coolant and the tertiary loop are expensive.

To mitigate these and other challenges, disclosed herein includes examples of molten salt reactor systems that include an in-core heat exchanger that can utilize either a liquid or gas coolant in the coolant loop. The gas coolant loop of the present disclosure may include a compressor that compresses the gas coolant prior to entering the in-core heat exchanger, and a turbine that utilizes the gas coolant after the gas coolant exits the heat exchanger to produce electricity. In one or more embodiments, the gas coolant may be carbon dioxide, air, nitrogen, helium, or other gases that can effectively receive heat in the heat exchanger and be released into the atmosphere.

In some embodiments, the reactor core and heat exchanger are located within a reactor vessel. Molten salt reactor systems that include one or more heat exchangers within the reactor vessel are generally referred to as “pool-type” reactors. A pool-type reactor may include all or substantially all of the functional components of a molten salt reactor integrated into a single contained unit. For example, the single contained unit of a pool-type reactor may integrate the primary functional elements of one or more of a graphite moderator, reactor vessel, heat exchangers, control rods, decay heat removal systems and/or other functional components into a single unit. In this regard, the pool-type reactor may circulate a fuel salt only within the single contained unit, rather than route the fuel into and out of multiple vessels arranged in a loop. The heat exchangers in pool-type reactors may be any type of heat exchanger that can withstand the temperature of the molten fuel salt, including but not limited to, shell-and-tube heat exchangers, double tube heat exchangers, printed circuit heat exchangers, tube in tube heat exchangers, and any other kind of heat exchanger. In some pool-type reactors, the heat exchanger and the reactor core may be separate, such that fission occurs in the reactor core and then the heated molten salt flows into the heat exchanger. In other embodiments, the heat exchanger may also act as the reactor core and reactor vessel (e.g., a shell-and-tube heat exchanger, or a printed circuit heat exchanger as described herein), wherein the heat exchanger includes the moderator material so that the fission reactions occur within the heat exchanger. In this instance, the heat exchanger can be referred to as an “in-core heat exchanger” because the heat transfer occurs at the reactor core of the system. On the other hand, “ex-core heat exchangers” in molten salt reactor systems are outside the reactor core and the reactor vessel, so that the molten fuel salt flows from the reactor vessel to the heat exchanger through pipes, and the heat transfer to the coolant occurs outside the reactor core. Molten salt reactor systems that utilized in-core heat exchangers undergo a more efficient heat transfer operation because the molten fuel salt does not travel through pipes out of the core before entering a heat exchanger, and so there is negligible heat loss using in-core heat exchangers relative to ex-core heat exchangers. In some embodiments, because the in-core heat exchangers have molten fuel salt flowing through at temperatures up to 1500 degrees Celsius, the material of the in-core heat exchanger may be a metal that can operate at those high temperatures, such as steel, nickel alloys, molybdenum alloys, tungsten alloys, or may be made of silicon carbide and carbon composites.

In multiple embodiments, the in-core heat exchanger of the disclosed molten salt reactor system may include a gas coolant side and a molten fuel salt side. In one or more embodiments, the gas coolant side of the in-core heat exchanger may have a coolant inlet for a coolant to flow into the heat exchanger, and a coolant outlet for the coolant to flow out of the heat exchanger. In many embodiments, the molten fuel salt side of the in-core heat exchanger may include a molten fuel salt inlet for molten fuel salt (or other fuel liquid) for the molten fuel salt to flow into the heat exchanger, and a molten fuel salt outlet for the molten fuel salt to flow out of the heat exchanger. In at least one embodiment, utilization of the in-core heat exchanger may allow for a minimized axial temperature gradient with minimal temperature change (e.g., less than 20 degrees Celsius, less than seven degrees Celsius) of the molten salt fuel between the inlet and the outlet of the heat exchanger at steady state operation.

Also disclosed herein is a printed circuit heat exchanger that may be utilized as an in-core heat exchanger. In multiple embodiments, the printed circuit heat exchanger may include a coolant side and a molten fuel salt side. In one or more embodiments, the coolant side of the printed circuit heat exchanger may have a coolant inlet for a coolant to flow into the heat exchanger, and a coolant outlet for the coolant to flow out of the heat exchanger. In many embodiments, the molten fuel salt side of the printed circuit heat exchange may include a molten fuel salt inlet for molten salt (or other fuel liquid) for the molten salt to flow into the heat exchanger, and a molten fuel salt outlet for the molten salt to flow out of the heat exchanger.

In various embodiments, the printed circuit heat exchanger may include a plurality of plates or heat exchange layers that are connected together to form a heat exchange array, wherein the plates or layers are stacked on top of one another. In many embodiments, the plurality of plates or layers may be made from a moderator material, such as graphite, silicon carbide, or industrial, synthetic diamond, which may result in a moderated/thermal spectrum reactor, or may be made of a metal such as steel, nickel alloys, molybdenum allows, or tungsten alloys, which may result in a fast neutron spectrum reactor. More generally, the moderator material may include substantially any material that is used to facilitate or control nuclear reactors within the core. For purposes of example, carbon may be used in many different forms including graphite, carbon fiber, diamond, amorphous carbon, diamond-like-carbon and could be combined in a composite (or potentially used separately as a single material in some cases) with different possible matrices including, but not limited to, silicon carbide, amorphous carbon, or even metal alloys. Beryllium oxide and zirconium hydride are ceramic materials that are sometimes used as a moderator as well. In this regard, the moderator material of the various in-core heat exchangers described herein may, in some cases, include, without limitation, certain carbon fiber/silicon carbide composites, industrial diamond/silicon carbide composites, carbon/carbon composites, metal alloy/carbon composites, beryllium oxide or beryllium oxide composites, and/or zirconium hydride and zirconium hybrid composites (which may require cladding), among other materials. In other examples, other materials may be used, as appropriate for a given application.

In many embodiments, each plate may include two layers that do not intersect or interact, so that the coolant and the molten fuel salt do not mix. Instead, the coolant and molten fuel salt flow through alternating layers in the plates to maximize heat transfer from the molten fuel salt to the coolant. In some embodiments, each layer includes flow channels chemically etched into the plate or baffles to obstruct flow to increase heat transfer across the plates. In one embodiment, molten fuel salt flowing in the printed circuit heat exchanger may flow in a layer that is in between two layers of coolant (the layer below and the layer above the layer the molten fuel salt is flowing through), and coolant flowing in the printed circuit heat exchanger may flow in a layer that is in between two layers of molten fuel salt, such as the layer below and the layer above the layer the coolant is flowing through (except for the coolant or fuel flowing in the top layer of the top plate and the coolant or fuel flowing in the bottom layer of the bottom plate, each of which flows on top of or underneath only one layer of opposing fluid).

In at least one embodiment, the in-core printed circuit heat exchanger may be about 1 meter cubed in volume for criticality, though the volume could be less or more depending on design details. In one embodiment, the in-core printed circuit heat exchanger may have about 300 plates and 600 layers and may have about 123,000 flow channels for fuel and coolant each; however, in other configurations, the heat exchanger may have more or fewer layers and flow channels. In at least one embodiment, the printed circuit heat exchanger may increase or maximize power density (relative to conventional heat exchangers in molten salt reactors). In some embodiments, high power density with respect to fuel volume increases fission product concentrations, and online fission separations become easier at high fission product concentrations. Additionally, maximizing high power density minimizes materials costs and borrowing costs, as molten salt reactors use expensive materials and coolants relative to other nuclear reactors, and increases the power output relative to volume of salt needed.

In several embodiments, the use of an ex-core heat exchanger leads to hot leg corrosion and cold leg deposition, which leads to a trade-off between power density and hot leg corrosion (e.g., minimizing hot leg corrosion minimizes power density). By utilizing the in-core heat exchanger of the present disclosure, the system is free from any “hot leg” or “cold leg” and so there is no trade-off occurring between power density and corrosion. Additionally, the power density from the molten salt reactor system using an in-core heat exchanger may be about twice the power output from a conventional light water reactor and about 5-10 times the power density of a conventional molten salt reactor system design. In some embodiments, the heat exchange per unit volume of the in-core heat exchanger with molten salt fuel may be up to five times greater than the heat exchange per unit volume for a standard shell and tube heat exchanger for the same pressure drop.

For the molten salt reactor system design with an in-core heat exchanger, the molten salt fuel decreases, eliminates or minimizes hot leg corrosion and cold leg deposition, has a high power density of about 200-400 MWth/cubic meter (which is about twice as much as a conventional light water reactor), and decreases or minimizes ex-core delayed neutron precursor or decay. Limiting ex-core delayed neutrons allows the delayed neutron fraction to remain high, even at high flow rates, which improves the ability of reactor operators to control the reactor power output and avoid sudden spikes in power if unexpected reactivity insertions occur.

Further, in utilizing a gas coolant, rather than a molten salt coolant, the capital infrastructure costs are decreased significantly, because the molten salt reactor system as disclosed would not have an intermediary loop with a molten salt coolant or systems needed to monitor and support such an intermediary loop, lowering the amount of salt volume needed to operate such a molten salt reactor system.

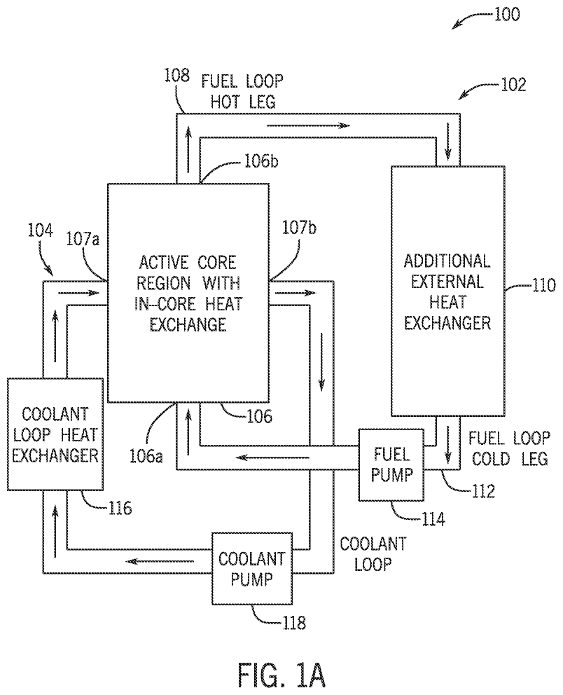

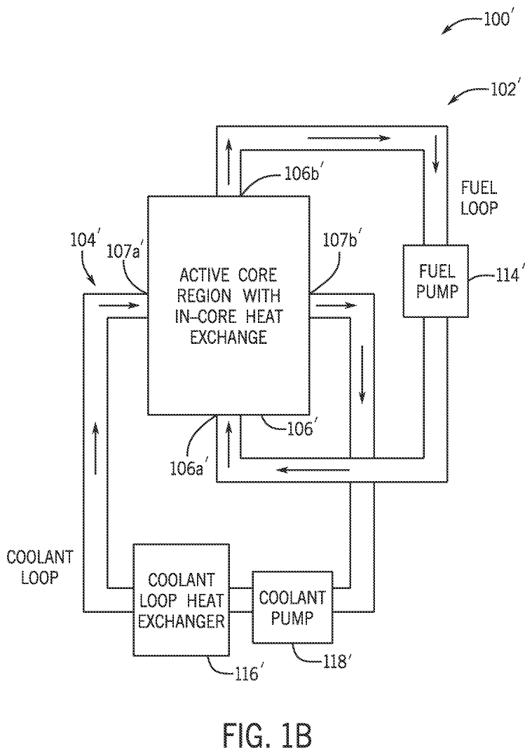

Referring now to the figures, for the purposes of example and explanation of the processes and components of the disclosed systems and methods, reference is made to FIG. 1, which illustrates an example, schematic overview of one embodiment of a molten salt reactor system 100. The molten salt reactor system 100 is an example of a molten salt reactor system that may utilize an example in-core heat exchanger, as described in greater detail below. As will be understood and appreciated, the example, schematic overview shown in FIG. 1 represents merely one system in which an in-core heat exchanger may be utilized. It will be understood that the in-core heat exchangers as described herein may be used in and with substantially any other molten salt reactor system, such as those associated with high temperatures and/or high pressures, among other characteristics, substantially analogous to those associated the molten salt reactor system 100 described herein.

Turning to FIG. 1A, the molten salt reactor system 100 may include a fuel loop 102 and coolant loop 104. In various embodiments, the fuel loop 102 (or fuel circulation system) includes an in-core heat exchanger 106, a fuel loop hot leg 108, an additional heat exchanger 110, a fuel loop cold leg 112, and a fuel pump 114. The fuel loop 102 circulates molten fuel salt, and the direction of flow of the molten salt fuel in the fuel loop 102 is denoted by arrows in FIG. 1A that proceed along the fuel loop 102. The coolant loop 104 (or coolant circulation system) includes the heat exchanger 106, a coolant loop heat exchanger 116, and a coolant pump 118. The coolant loop 104 circulates a coolant, such via operation of the coolant pump 118, and the direction of flow of the coolant in the coolant loop is denoted by arrows in FIG. 1A. For example, the coolant may flow into the in-core printed circuit heat exchanger 106 at a coolant inlet 107a and flow out of the in-core printed circuit heat exchanger 106 at a coolant outlet 107b, as denoted by the directional arrows on the coolant loop 104. In many embodiments, the coolant may be at an increased temperature upon exiting the in-core printed heat exchanger 106. In one or more embodiments, the coolant may flow to or be pumped to the coolant loop heat exchanger 116 to transfer heat to a tertiary fluid (e.g., steam) that may interact with power generation components (e.g., a turbine) to generate power. In another embodiment, the coolant may interact with power generation components to generate power.

In the example of FIG. 1A, the in-core printed heat exchanger 106 includes a moderator, such as being formed partially or fully from a moderator material (e.g., a graphite moderator, but not limited to a graphite moderators). The moderator material may be configured to control one or more parameters of a fission reactor within the in-core printed heat exchanger 106. The moderator material may further be configured to transfer heat from the fuel loop 102 to the coolant loop 104 within the in-core printed heat exchanger 106. In this regard, the in-core printed circuit heat exchanger 106 may be configured to permit, cause, and/or control fission reactions of any fuel salt being circulated through the fuel loop 102, while also allowing for heat exchange between the fuel loop 102 and the coolant loop 104. For example, the moderator material of the in-core printed circuit heat exchanger 106 may be arranged to allow the temperature of the molten salt fuel within the system to be about 700 degrees Celsius, and allows the in-core printed heat exchanger to function as the molten salt reactor. In many embodiments, as shown by the directional arrows on FIG. 1A, the fuel side may enter the in-core printed circuit heat exchanger 106 at a fuel side inlet 106a and exit the in-core printed circuit heat exchanger 106 at a fuel side outlet 106b. In some embodiments, as shown in FIG. 1A, the fuel pump 114 may cause the molten salt to circulate along the fuel loop 102 and encourage the molten salt to travel from the fuel side outlet 106b to the fuel side inlet 106a by increasing the pressure of the molten salt fuel (because the pressure of the molten salt fuel drops along the fuel loop 102, such as at the additional heat exchanger 110).

As shown by FIG. 1A, the system 100 may include the additional heat exchanger 110 within the primary loop 102. In at least one embodiment, the additional heat exchanger 110 may include various configurations of printed circuit heat exchangers, shell-and-tube heat exchangers, or any other kind of heat exchangers. In one or more embodiments, the additional heat exchanger 110, as shown in FIG. 1A may increase the power generation of the system because the system is transferring more heat to secondary and/or tertiary power generation loops. In some embodiments, the number of additional heat exchangers along the fuel loop 102 is limited by the pressure drop that occurs in the system in utilizing the additional heat exchangers (e.g., molten salt fuel pressure drops across each heat exchanger). Further, one or more of the one or more additional heat exchangers may include a moderator and function as an additional reactor core, substantially analogous to the in-core printed circuit heat exchanger 106. Additionally, the system 100 may include a chemical separations facility on the primary loop 102 and/or other facility or process that may use heat from the primary loop 102.

It will be appreciated that in some configurations, the additional heat exchanger 110 may be omitted, for example, as shown in 100′ of FIG. 1B. The system 100′ may be substantially analogous to the system 100 of FIG. 1A and include a fuel loop 102′, an in-core printed circuit heat exchanger 106′, a fuel pump 114′, a coolant loop 104′, a coolant loop heat exchanger 116′, a coolant pump 118′, a fuel side inlet 106a′, a fuel side outlet 106b′, a coolant inlet 107a, and a coolant outlet 107b. Notwithstanding the foregoing similarities, the system 100′ does include an additional heat exchanger along the fuel loop. As such, the system 100′ does not include fuel loop hot leg or cold leg as described above in relation to FIG. 1A. In this regard, rather the remove heat along the fuel loop 102′, the operation of the fuel pump 114′ may cause the fuel contained therein to increase in temperature. This configuration may be desirable, for example, in order to retain the fuel at a high overall temperature throughout the fuel loop 102′ in order to transfer a maximum amount of heat from the fuel of the fuel loop 102′ to the coolant of the coolant loop 104′.

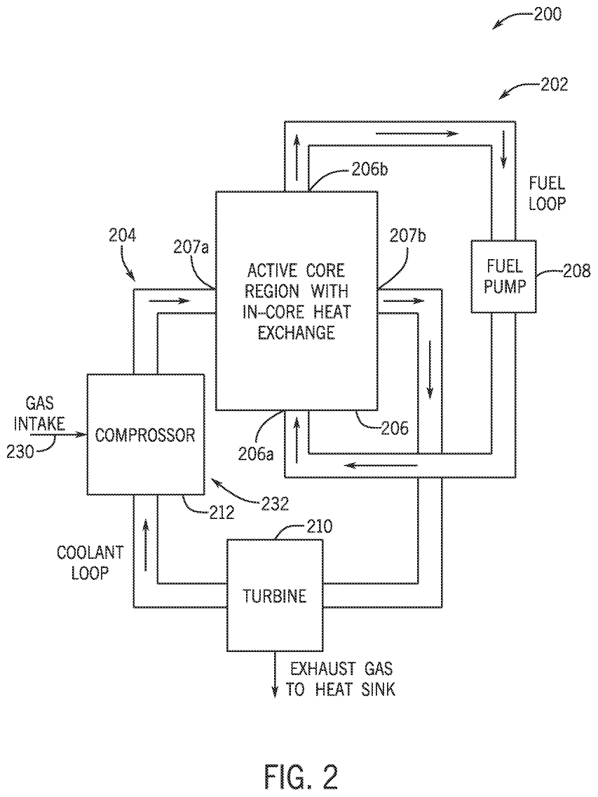

The systems 100 and 100′ described above generally contemplate using a molten salt as a coolant for propagation through the respective coolant loops 104, 104′. As described herein, the various in core-printed circuit heat exchangers of the present disclosure may use gas as a coolant. For example, certain compositions of gas, including supercritical CO₂, a helium, and other gasses, including various other inert gasses may establish ideal and efficient cooling mediums for receiving heat from the fuel salt of the various fuel loops described herein. In this regard, FIG. 2 shows a design of a molten salt reactor system 200 utilizing an in-core heat exchanger with a gas coolant, according to one example of the present disclosure. The system 200 may be substantially analogous to the system 100′ of FIG. 1B and include a fuel loop 202 (or fuel circulation system), an in-core printed circuit heat exchanger 206, a fuel pump 208, a coolant loop 204, a fuel side inlet 206a, a fuel side outlet 206b, a coolant inlet 207a, and a coolant outlet 207b.

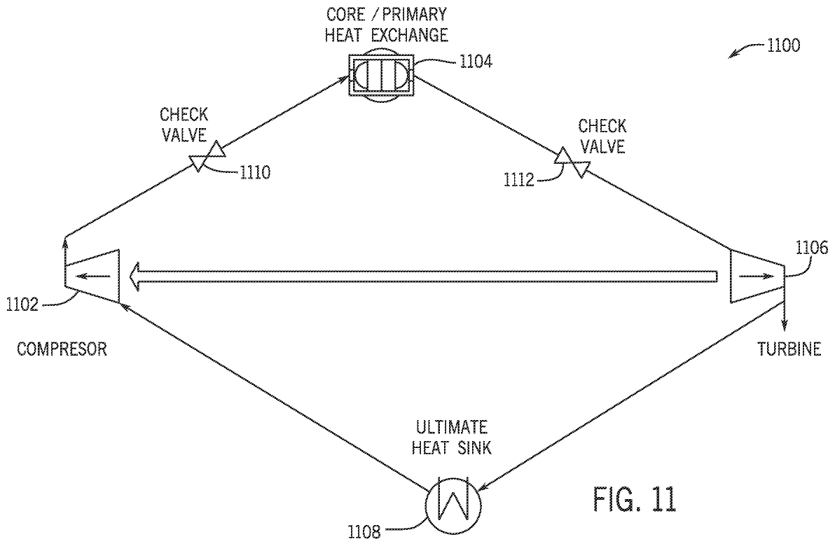

Notwithstanding the foregoing similarities, as shown on FIG. 2, the system 200 may include a turbine 210 and a compressor 212, each positioned along and included with the coolant loop 204 (or coolant circulation system). The compressor 212 may take in the gas coolant from the atmosphere or other gas coolant source (e.g., via gas intake 230), or may receive recycled gas coolant from the turbine 210 (e.g., via fuel gas flow 232). In this regard the turbine 219 may be configured to perform work from the elevated temperature coolant. The compressor 212 increases the pressure and flow rate of the gas coolant prior to entering the in-core heat exchanger 206. The gas coolant flows from the compressor 212 into the in-core heat exchanger 206 at a coolant inlet 207a and flows out of the in-core heat exchanger 206 at a coolant outlet 207b, as denoted by the directional arrows on the coolant loop 204. In many embodiments, the gas coolant increases in temperature across the in-core heat exchanger 206 due to the heat transfer from the molten fuel salt. As such, the gas coolant may at an increased temperature upon exiting the in-core printed heat exchanger 206. In this regard, in one or more embodiments, the heated gas coolant may flow from the in-core heat 206 exchanger to the turbine 210, which utilizes the heated gas coolant to rotate a generator to generate power. In one embodiment, upon the utilization of the gas coolant at the turbine 210, the gas coolant may be exhausted to a heat sink (e.g., the atmosphere or a collection tank for scrubbing the gas before releasing to atmosphere, as indicate via heat sink flow 234), or may be recycled in the coolant loop 204 to the compressor 212, as described above. Additionally, a portion of the energy derived from the expansion of the heated gas coolant (the “Fuel gas” flow 232) in the turbine 210 may be utilized to drive the compressor 212. Such operation may allow the system 200 to operate as and benefit from a Brayton cycle, as described in greater detail herein at FIG. 11.

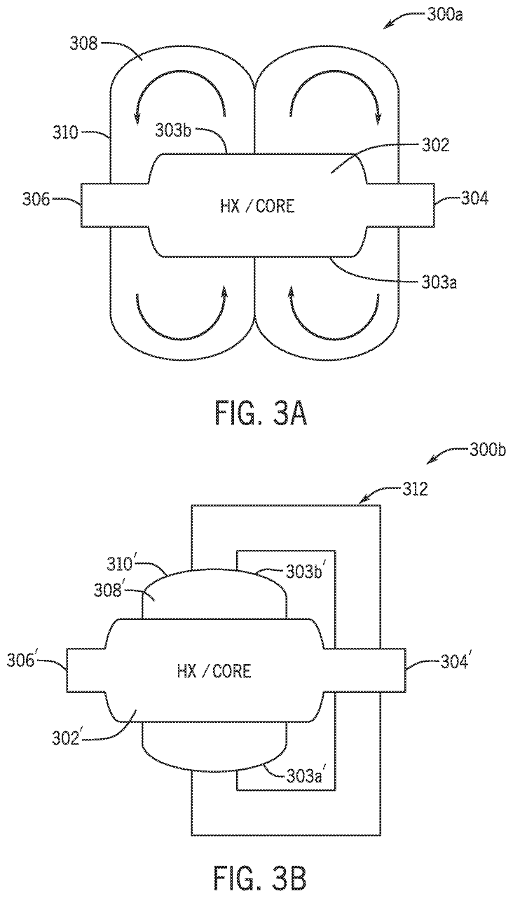

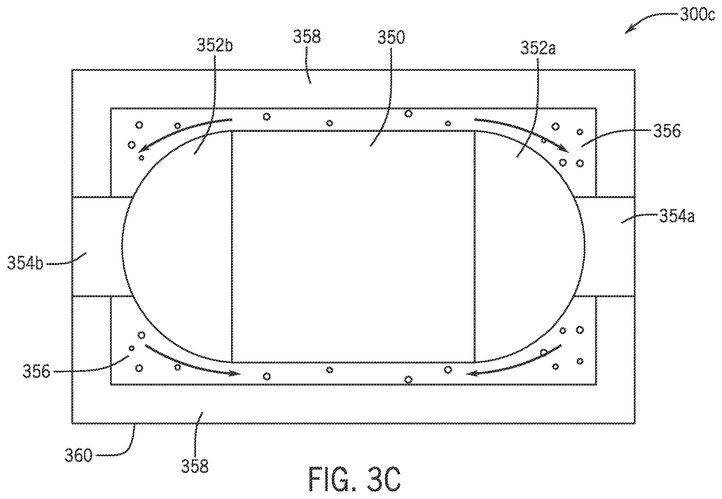

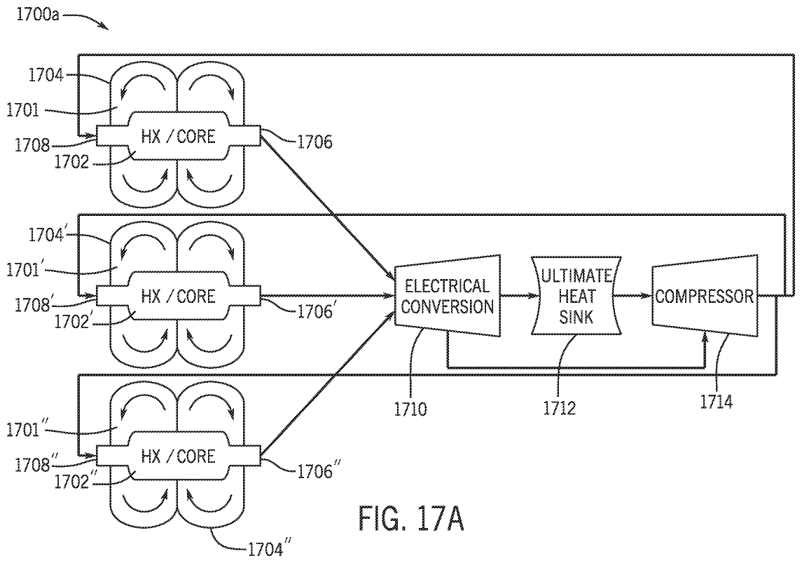

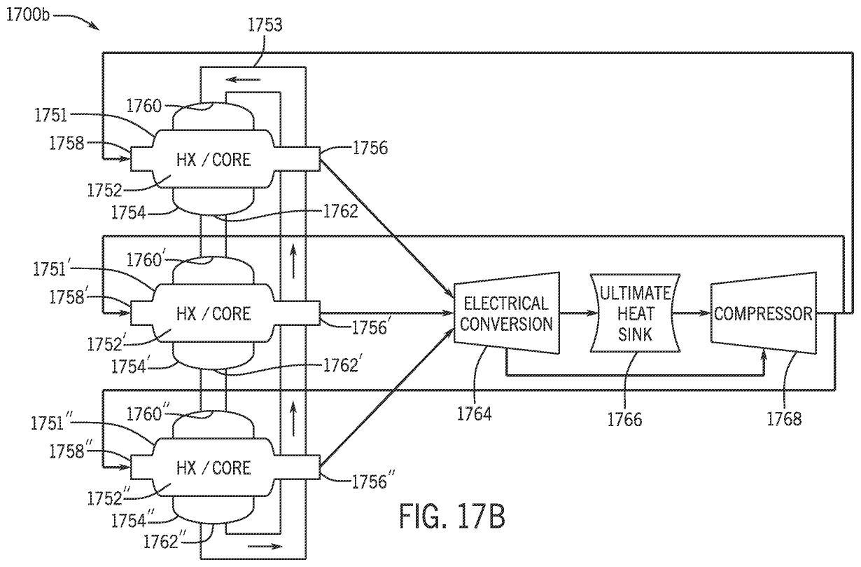

FIG. 3A depicts a schematic representation of an example molten salt reactor system 300a. The molten salt reactor system 300a is depicted as a “pool-type” reactor. As described herein, such pool-types reactors may include all or substantially all of the functional components of a molten salt reactor integrated into a single contained unit. For example, the single contained unit of a pool-type reactor may integrate the primary functional elements of one or more of a graphite moderator, reactor vessel, heat exchangers, control rods, decay heat removal systems and/or other functional components into a single unit. In this regard, the pool-type reactor may circulate a fuel salt only within the single contained unit, rather than route the fuel into and out of multiple vessels arranged in a loop. In this regard, FIG. 3A, shows the system 300a as including a reactor vessel 310 having an in-core printed circuit heat exchanger 302. The in-core printed circuit heat exchanger 302 may be substantially analogous to any of the in-core printed circuit heat exchangers described herein, and include a coolant inlet 304 and a coolant outlet 306, as shown in FIG. 3A. Notwithstanding the foregoing similarities, the in-core-printed circuit heat exchanger 302 may be arranged substantially within the flow or circulation path of a molten salt 308. For example, the in-core printed circuit heat exchanger 302 may be arranged substantially within the reactor vessel 310 such that the in-core printed circuit heat exchanger 302 may receive a flow of the molten salt 308 circulating therein (e.g., such as receiving the molten salt 308 generally along a fuel side inlet region 303a, and as emitting the molten salt 308 generally along a fuel side outlet region 303b). The in-core printed circuit heat exchanger 302 may function as the “core” of the reactor shown in FIG. 3A, and accordingly, including various moderator materials, as described herein, to facilitate the undergoing of fission reactions with the molten salt 308, and which may occur within the in-core printed circuit heat exchanger 302. The coolant inlet 304 and the coolant outlet 306 are show extending from the in-core printed circuit heat exchanger 302 outside of the reactor vessel 310. For example, the coolant inlet 304 and the coolant outlet 306 may facilitate the circulation of a coolant along a coolant loop that extends outside of the reactor vessel, substantially analogous to the coolant loops 104, 104′ and 204 described herein. As described in greater detail below with reference to FIG. 17A, multiple units of the system 300a may be arranged together in a chain in order to facilitate power generation and efficiency.

FIG. 3B depicts a schematic representation of another example molten salt reactor system 300b. The system 300b may be substantially analogous to any of the systems 100, 100′ or 200 and include a fuel loop 312, an in-core printed circuit heat exchanger 302′, a fuel side inlet 303a′, a fuel side outlet 303b′, a coolant inlet 304′, and a coolant outlet 306′. The coolant inlet 304′ and the coolant outlet 306′ may establish a coolant loop therebetween, such as any of the coolant loops shown and described in relation to FIGS. 1A-2. As described in greater detail below with reference to FIG. 17B, multiple units of the system 300b may be arranged together in a chain in order to facilitate power generation and efficiency.

With reference to FIG. 3C, a schematic representation of another example molten salt reactor system 300c is depicted. The system 300c depicted in FIG. 3C may be a pool-type reactor substantially analogous to the system 300a described above in relation to FIG. 3A. In this regard, the system 300a may include an in-core heat exchanger or reactor core 350 having a coolant inlet distributor 352a that is connected to a coolant inlet 354a, and a coolant outlet distributor 352b that is connected to a coolant outlet 354b. The in-core heat exchanger 350 may be surrounded by molten fuel salt 356 within a reactor vessel 358. In some cases, the reactor vessel 358 may include or be associated reflectors, including certain graphite reflectors. The coolant inlet 354a and coolant outlet 354b penetrate the reactor vessel 358. The heat exchanger 350 may also have a molten fuel salt inlet and a molten salt outlet (not shown), so that the molten fuel salt can enter into the heat exchanger 350 to facilitate the heat transfer between the fuel salt and the gas coolant. In this example, the heat exchanger 350 is within the reactor vessel 358 as a pool-type reactor (i.e., the heat exchanger 350 is a printed circuit heat exchanger or some other heat exchanger that can support the fission reactions within the heat exchanger, as described herein), and the molten fuel salt 356 flows around the heat exchanger 350 in an annulus shape, as indicated by the flow arrows shown in FIG. 3C. In addition, the system 300c may also include a molten fuel salt pump that pumps the molten fuel salt back to the fuel salt inlet.

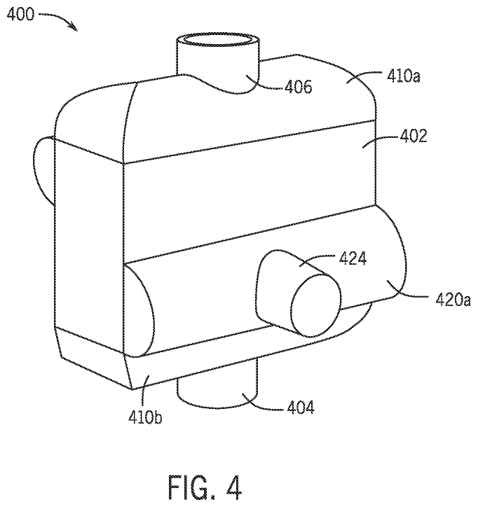

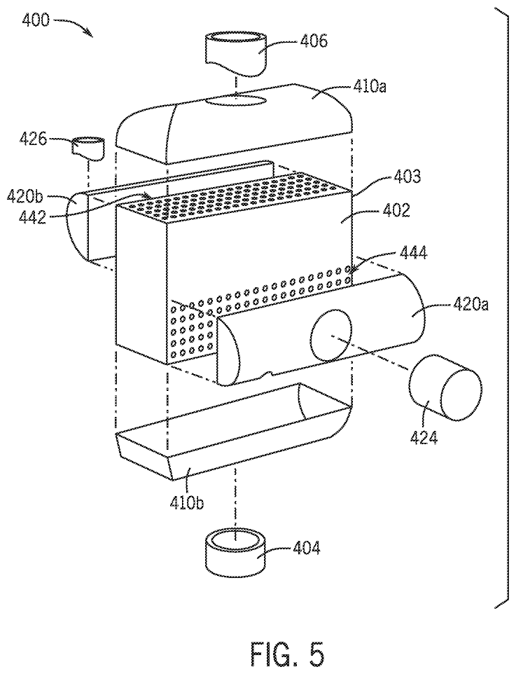

FIGS. 4-5 depict an example in-core printed circuit heat exchanger 400 of the present disclosure. The in-core printed circuit heat exchanger 400 may be substantially analogous to the in-core printed circuit heat exchangers 106, 106′, and 206 described herein in relation to FIGS. 1A-2. For example, the in-core printed circuit heat exchanger 400 may be configured to control and/or promote the occurrence of fission reactions in a fuel salt that flows therethrough. Further, the in-core printed circuit heat exchanger 400 may be configured to permit the transfer of heat therein between the fuel salt and a coolant medium (e.g., a coolant salt, a coolant gas, and/or other coolant medium as may be appropriate for a given application). In the example of FIGS. 4-5, the in-core printed circuit heat exchanger 400 may include a heat exchange array 402. The heat exchange array 402 may define the main structure through which a fuel salt and a coolant pass through in order to exchange heat therebetween. The heat exchange array 402 may further facilitate and/or control one or more fission reactions in the fuel salt. In this regard, the heat exchange array 402 may be formed from a moderator material 403, including certain graphite materials. The heat exchange array 402 may be constructed via an additive manufacturing process, which may facilitate the creation of intricate and numerous and layered flow channels in a variety of direction throughout the moderator material 403. It will be appreciated that the heat exchange array 402 may be constructed in a variety of shapes and sizes, as may be needed to support reactor design and neutronics. In this regard, while FIGS. 4-5 show the heat exchange array 402 as a roughly cuboid or rectangular prism shape, in other cases, other shapes are possible. For example, the heat exchange array 402 may be constructed, in other embodiments as having a roughly cubic shape for neutronic purposes.

In the example of FIGS. 4-5, the heat exchange array 402 is shown as including a plurality of fuel channels 442 extending through the moderator material 403. Further shown in FIGS. 4-5, the heat exchange array 402 is shown as including a plurality of coolant channels 444 extending through the moderator material 403. The plurality of fuel channels 442 may be fluidically isolated from the plurality of coolant channels 444. As such, the plurality of fuel channels 442 may be adapted to receive a flow of a fuel salt and route said flow of fuel salt through the moderator material 403 without fluid contact with the coolant. Similarly, the plurality of coolant channels 444 may be adapted to receive a flow of a coolant and route said flow of coolant through the moderator material 403 without fluid contact with the fuel salt.

To facilitate the foregoing, the in-core printed circuit heat exchanger 400 is shown as including a pair of fuel distributors 410a, 410b and a pair of coolant distributors 420b, 420b. Broadly, the pair of fuel distributors 410a, 410b may be configured to provide fuel to each channel of the plurality of fuel channels 442, and may further be configurated to collect the fuel from each channel of the plurality of fuel channels 442 and combine the fuel into a single fuel exit flow. For example, the fuel distributor 410a may be fluidically coupled with a fuel inlet 404 that generally delivers the fuel salt to the heat exchanger 400 in a single stream. The fuel distributor 410a then routes and facilitates the transition of this flow from the fuel inlet 404 to the plurality of channels 442. Further, the fuel distributor 410b may be fluidically coupled with a fuel outlet 406 that generally collects the fuel salt from each channel of the plurality of fluid channels 442 and combines this flow into a single flow for exit from the heat exchanger via the fuel outlet 406. While the pair of fuel distributors 410a, 410b are shown as covering generally all of a surface of the heat exchange array 402 (e.g., the surface having the fuel channels 442), in other cases, the pair of fuel distributors 410a, 410b may cover only a portion of a surface of the heat exchange array 402, based on a configuration and arrangement of the fuel channels 442.

With respect to the pair of coolant distributors 420a, 420b, broadly, the pair of coolant distributors 420a, 420b may be configured to provide the coolant to each channel of the plurality of coolant channels 444, and may further be configured to collect the coolant from each channel of the plurality of coolant channels 444 and combine the coolant into a single coolant exist flow. For example, the coolant distributor 420a may be fluidically coupled with a coolant inlet 424 that generally delivers the coolant to the heat exchanger 400 in a single stream. The coolant distributor 420a then routes and facilitates the transition of this flow from the coolant inlet 424 to the plurality of channels 444. Further, the coolant distributor 410b may be fluidically coupled with a coolant outlet 426 that generally collects the coolant from each channel of the plurality of fluid channels 444 and combines this flow into a single flow for exit from the heat exchanger via the coolant outlet 426. While the pair of coolant distributors 420a, 420b are shown as covering only a portion of a surface of the heat exchange array 402 (e.g., the portion shown as having the coolant channels 444), in other cases, the pair of coolant distributors 420a, 420b may cover all or substantially all of a surface of the heat exchange array 402.

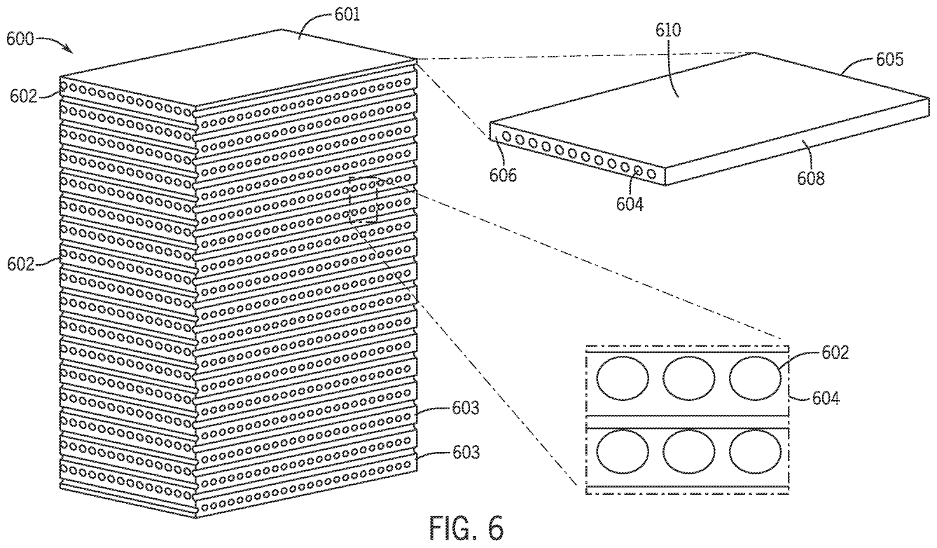

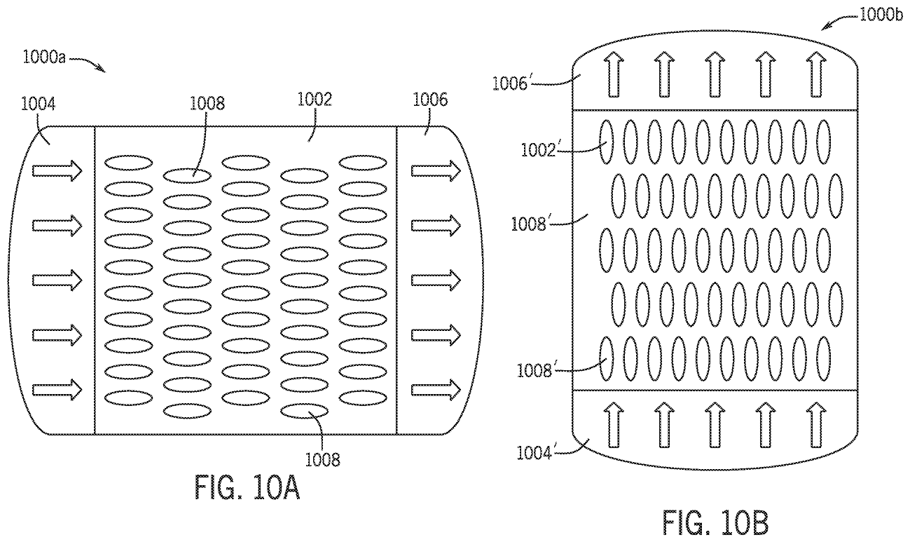

Turning to FIG. 6, a heat exchange array 600 is disclosed. The heat exchange array 600 may be substantially analogous to the heat exchange array 402 described above in relation to FIGS. 4 and 5, and may include a moderator material 601 that defines a plurality of fuel channels 602 and a plurality of coolant channels 603, each extending through a complete thickness of the moderator material 601. In this regard, the heat exchange array 600 shown in FIG. 6 may be used in, or as a component of, the in-core printed circuit heat exchanger 400 shown and described in relation to FIGS. 4 and 5. FIG. 6 shows the plurality of fuel channels 602 and the plurality of coolant channels 603 arranged in a cross flow pattern throughout the moderator material 601. In other cases, and as described herein in relation to FIGS. 10A and 10B, the fuel channels and the coolant channels may be arranged to establish a parallel flow of the fuel relative to the coolant, an opposing flow of the fuel relative to the coolant, and/or a variant or combination thereof.

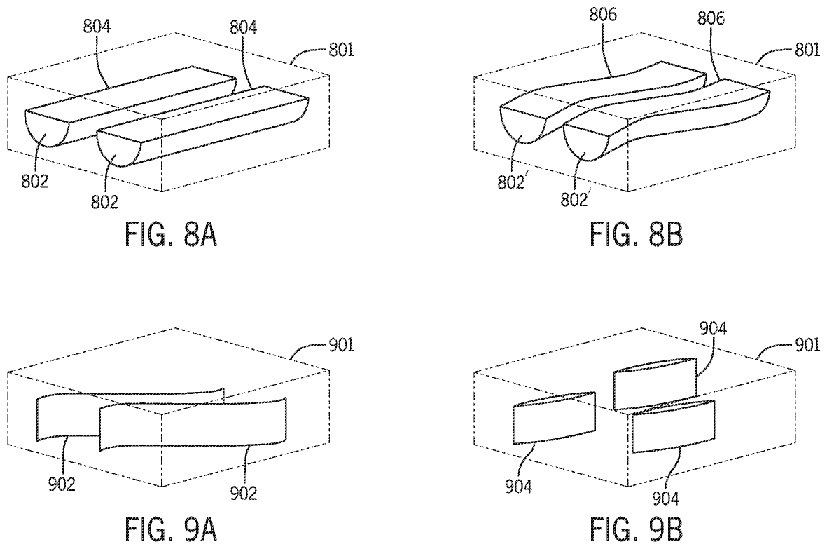

The heat exchange array 600 may be formed as a single, one-piece structure of moderator material 601. The single, one-piece structure may nevertheless include a collection of stacks or layer or plates, such as a layer 608 shown with reference to FIG. 6. Each stack 608 may define a flow path or run of the particular channel through the moderator material 601. For example, the given stack 608 define a complete flow path for individual channels of the plurality of fuel channel 602 through the moderator material 601, such as flow path extending from the first surface 604 to the second surface 605 of the moderator material 601. In the example of FIG. 6, the moderator material 601 may house alternating layers of the fuel channels and the coolant channels such that adjacent layers or stack house either channels of the plurality of fuel channels 602 of channels of the plurality of coolant channels 603. In this regard, the heat exchanger 600 may facilitate efficient transfer of heat between the fuel of the fuel channel and the coolant of the coolant channels, as such channels are always adjacent channels of the opposite medium. In some cases, and as described herein in relation to FIGS. 8A-9B, the flow paths defined by the fuel channels 602 and/or the coolant channels 603 may be specifically configured to promote heat transfer by implementing the channels according to a heat-transfer efficient shape and/or by establishing a tortuous path through the moderator material, including by including one or more baffle structures therein to promote the tortuous flow path of the fuel and/or the coolant.

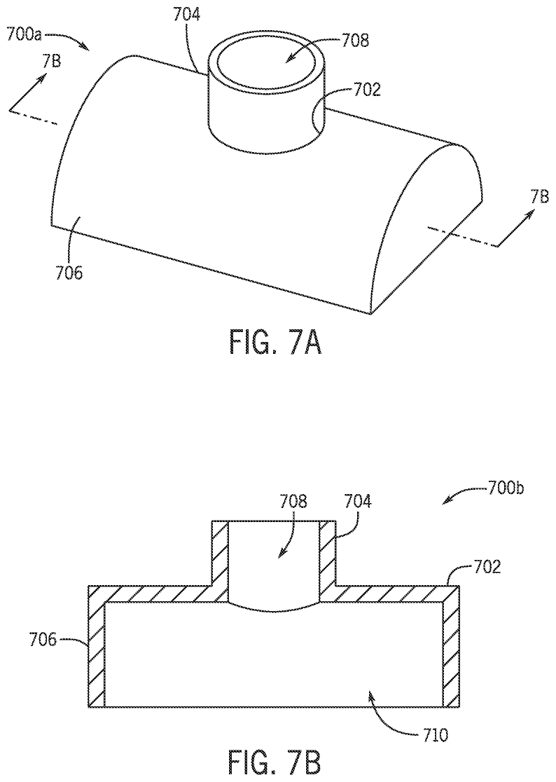

With reference to FIGS. 7A and 7B, an example distributor 700 is shown. The distributor 700 may be substantially analogous to any of the pair of fuel distributors 410a, 410b or the pair of coolant distributors 420a, 420b described above, and the distributors 700 may be used with or as a component of the heat exchanger 400 of FIGS. 4 and 5. While many configurations of distributors are possible and contemplated herein, the distributor 700 is shown as including a body 702 that defines a port region 704 and a distribution region 706. The body 702 may be formed from any appropriate material configured to withstand the temperature and pressure of either the fuel salts or coolants contemplated herein. In some cases, the body 702 may be formed from a neutron reflector material, which may be advantageous in order to shield any surrounding equipment from the fission reactions which may occur within the in-core heat exchanger. Broadly, the port region 704 may define an opening 708 that is configured to receive and/or emit a single flow of fluid. The distribution region 706 may define a broad opening 710 and is configured to receive and/or emit a distributed flow of fluid relative to one of the pluralities of channels of the heat exchanger. In other cases, other configurations of distributors are contemplated herein.

As described herein, the shape of the channels of the moderator material may be specifically tuned to promote heat transfer properties. Accordingly, the channels may have a height, width, length, contour and/or other property as desired. With reference to FIG. 8A, examples channels 802 are shown having a shape 804. The channels 802 may be coolant or fuel channels formed through a moderator material 801, such as any of the coolant or fuel channels described herein. In the example of FIG. 8A, the shape 804 is shown as a generally semi-circular shape that processes along a generally straight path. In other examples, the shape 804 may have substantially any other height or width or other dimension, and may resemble various other shapes, including a square, a triangle, and halfmoon and/or other shapes. In yet other examples, and as shown in FIG. 8B, channels 802′ may proceed along a serpentine or S-path 806 through a moderator material. Additionally or alternatively, the channels 802′ may include or otherwise define hard 30° or 45° zigzags, which may promote additional turbulence and improves heat transfer.

Additionally or alternatively, the layers of the moderator material may define baffles or obstacles for the fluid flow therethrough. In this regard, FIGS. 9A and 9B show an another example in which, with reference to FIG. 9A, flow obstacles 902 are define in the moderator material 901. Accordingly, the moderator material 901 may generally include an open channel or passage that allows fluid to flow therethrough, with the flow obstacles 902 defining a tortuous path for the flow through the moderator material 901. In the example of FIG. 9A, the flow obstacles 902 are shows as a generally ribbon-type shape. It will be appreciated that the flow obstacles may substantially any shape in order to promote heat transfer, such as being in the oval shape 904 as shown with reference to FIG. 9B.

With reference to FIGS. 10A and 10B, example layers of an heat exchange array of the present disclosure are depicted for purposes of describing the cross flow, the parallel flow, and the opposing flow of the heat exchangers described herein. For example, and with reference to FIG. a layer or plate 1000a is shown. The layer or plate 1000a may be a layer of any of the heat exchange arrays described herein and may be formed from a moderator material. The layer 1000a is therefore shown as include a layer surface 1002, a fluid inlet distributor 1004, a fluid outlet distributor 1006, and a series of baffles 1008. Broadly, the layer 1000a may receive a flow of fluid at the fluid inlet distributor 1004 and route and channel the flow along the surface 10002 to the fluid outlet distributor 1006. Along the surface 1002 the fluid may encounter baffles 1008 which may be disrupt the flow and create a potentially turbulent flow that promotes heats transfer between the fluid of the layer 1000a and the fluid of an adjacent layer.

FIG. 10B shows a layer 1000b that may be a layer arranged adjacent with the layer 1000a. The layer 1000b may be substantially analogous to the layer 1000a and include a layer surface 1002′, a fluid inlet distributor 1004′, a fluid outlet distributor 1006′, and a series of baffles 1008′. In operation, the layer 1000b may be configured to route one of a fuel salt or a coolant therethrough, the layer 1000a may be configured to route the other of the fuel salt or the coolant therefrom. The layers 1000a, 1000b may be arranged adjacent one another and in a manner to promote one of a cross flow of the fuel relative to the coolant, a parallel flow of the fuel relative to the coolant, or an opposing flow of the fuel relative to the coolant. With respect to a cross flow, the layers 1000a, 1000b may be arranged relative to one another such that the respective flows (as indicated by arrows shown in FIGS. 10A and 10B) are generally perpendicular to one another. With respect to a parallel flow, the layers 1000a, 1000b may be arranged relative to one another such that the respective flows are generally parallel to one another and each pointing or indicating in a common direction. With respect to an opposing flow, the layers 1000a, 1000b may be arranged relative to one another such that the respective flows are generally parallel to one another and each, respectively points or indicating in an opposing direction.

Turning to FIG. 11, an example gas coolant loop of the present disclosure is depicted, such as that which is shown generally in FIG. 2. The gas coolant loop 1100 includes a gas compressor 1102, an in-core heat exchanger 1104, a turbine 1106, and an ultimate heat sink 1108. The gas coolant loop 1100 may also include check valves 1110 and 1112. The in-core heat exchanger may be the in-core heat exchanger 100, 100′, 200, 300a, 300b, 300c, 400, or any other in-core heat exchanger. The compressor 1102 may take in the gas coolant from the ultimate heat sink 1108 or other gas coolant source. The compressor 1102 increases the pressure and flow rate of the gas coolant prior to entering the in-core heat exchanger 1104. The gas coolant flows from the compressor 1104 into the in-core heat exchanger 1104 at a coolant inlet (e.g., coolant inlet 354a of FIG. 3C) and flows out of the in-core heat exchanger 1104 at a coolant outlet (e.g., coolant outlet 354b of FIG. 3C). In many embodiments, the gas coolant increases in temperature as it flows across the in-core heat exchanger 1104 due to the heat transfer from the molten fuel salt and is at an increased temperature upon exiting the in-core printed heat exchanger 1104. In one or more embodiments, the heated gas coolant may flow from the in-core heat exchanger to the turbine 1106, which utilizes the heated gas coolant to rotate a generator to generate power. In one embodiment, upon the utilization of the gas coolant at the turbine 1106, the gas coolant may be exhausted to the ultimate heat sink 1108 (e.g., the atmosphere or a collection tank for scrubbing the gas before releasing to atmosphere), or may be recycled in the gas coolant loop 1100 to the compressor 1102. Additionally, a portion of the energy derived from the expansion of the heated gas coolant in the turbine 1106 may be utilized to drive the compressor 1102. The check valves 1110 and 1112 may prevent backwards flow from the gas coolant so that the gas coolant only flows in the desired direction in the gas coolant loop 1100. Check valve 1110 may also prevent the gas coolant from flowing forward through the gas coolant loop 1100 until the gas coolant has been compressed to a certain pressure. Check valve 1112 may also ensure that the gas coolant exiting the in-core heat exchanger 1104 is at a uniform temperature and/or pressure before the gas coolant can flow forward in the gas coolant loop 1100.

In several embodiments, in a situation when a fuel pump (e.g., fuel pump 114, 208 and so on) fails, the molten fuel salt will remain in the reactor core longer since the pump is not pumping the molten fuel salt to flow out of the reactor core. A transient model was created for this fuel pump accident scenario, which determined that a gas coolant (e.g., carbon dioxide) may be used as an effective coolant to transfer heat from the molten fuel salt in the reactor core during a fuel pump failure, in order to keep the molten fuel salt temperature in a safe range. The transient model also determined that the fission rate within the molten salt in the reactor core decreases enough to match the heat exchange rate across the heat exchanger. The transient model used the molten salt reactor system 350, but the findings may be applicable to any in-core heat exchanger within a molten salt reactor system To make these determinations, certain relationships are established. For example, the rate of heat exchange across the heat exchanger (and therefore, power production) is determined at least in part by the heat exchange system (e.g., the physical set-up of the heat exchanger) and rate of cooling, including the molten fuel salt temperature and flow rate, and the gas coolant temperature and flow rate. The fuel temperature determines the neutron multiplier (“k-effective”), and k-effective determines the fission power production rate at the next time step. The gas coolant mass flow rate is determined by at least the heat exchange rate across the heat exchanger. The molten salt fuel temperature at the molten fuel salt outlet of the heat exchanger determines at least the fuel inlet temperature after mixing with ex-core molten fuel salt, and the fuel outlet temperature is based on the energy balance of the heat exchange rate and the fission power rate

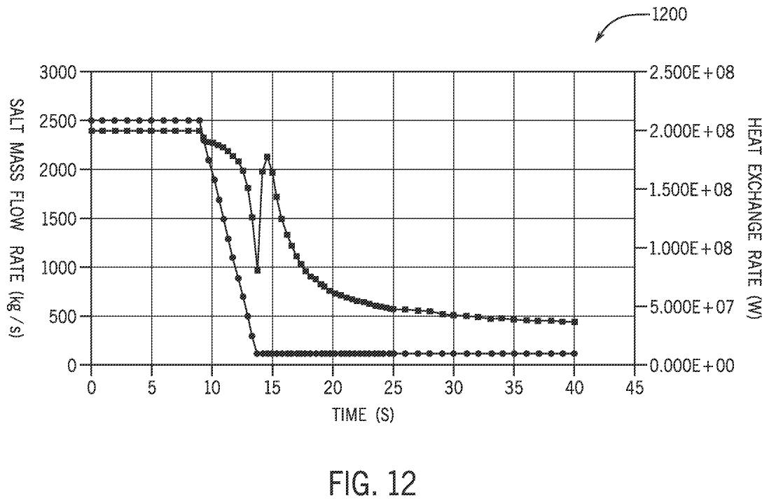

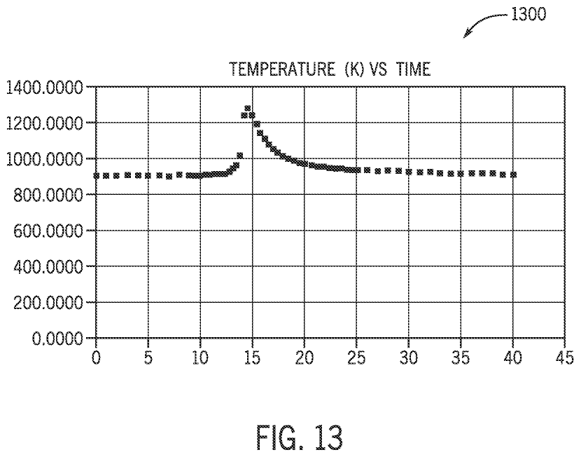

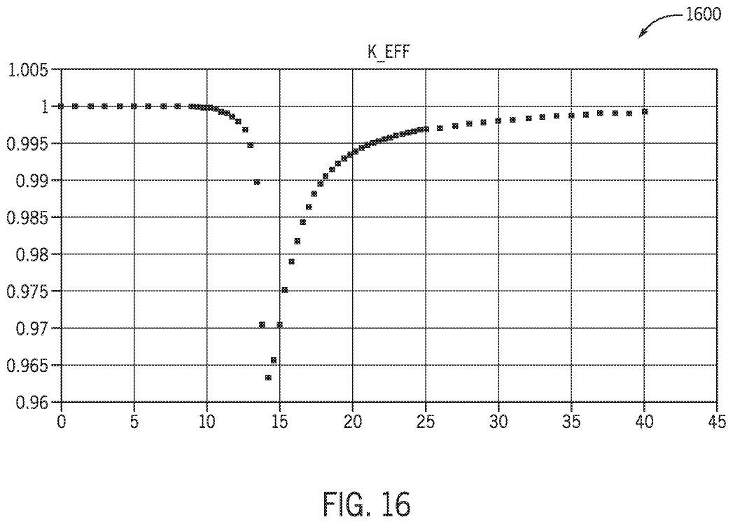

As the molten fuel salt remains in the reactor core, the increased exposure to the nuclear fission reactions results in a brief increase in temperature of the molten fuel salt in the reactor core (as shown by chart 1300 of FIG. 13), since it remains in the reactor core longer than in normal settings. Additionally, heat exchange rate between the fuel salt and the gas coolant is affected in part by the flow rate of the fuel salt, and so when the fuel salt flow rate decreases upon a fuel salt pump failure, the heat exchange rate decreases, causing more heat to stay with the molten fuel salt (as shown by chart 1200 of FIG. 12). However, the reactivity coefficient (k effective) decreases as the temperature of the fuel salt increases (as shown by chart 1600 of FIG. 16), which slows down the fission reactions, causing the molten fuel salt to decrease in temperature. Additionally, the brief increase in temperature in the molten fuel salt also causes the heat exchange rate to increase, as the heat exchange rate is also dependent on the temperature of the molten fuel salt, and so the brief increase in temperature of the fuel salt causes a similar brief increase in heat exchange rate across the heat exchanger (as shown by chart 1200 of FIG. 12). Since the mass flow rate of the gas coolant (e.g., carbon dioxide) is dependent on the heat exchange rate, the mass flow rate of the carbon dioxide sees a similar brief increase in mass flow rate at about the same time as the increase in heat exchange rate across the heat exchanger (as shown by chart 1500 of FIG. 15).

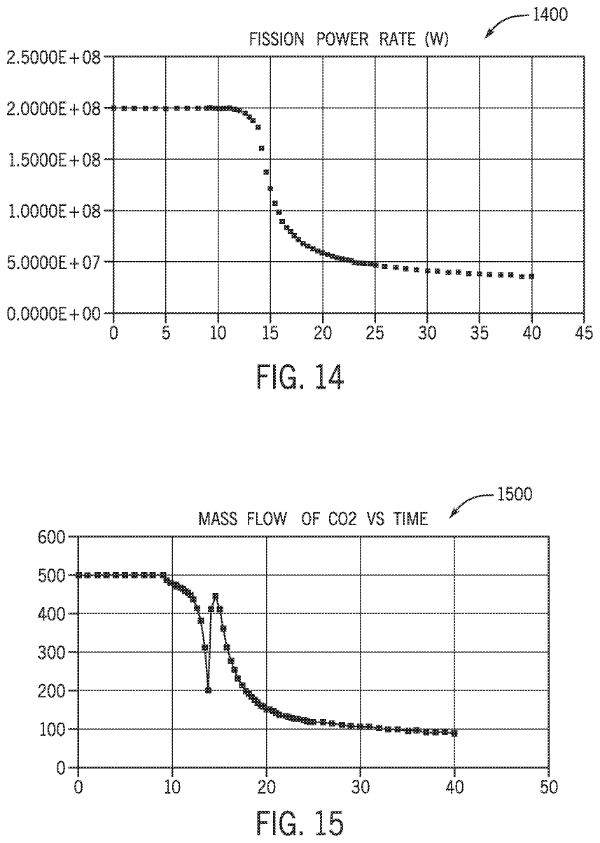

The transient model was evaluated with an initial fission power rate of 200 megawatts (as shown by chart 1400 of FIG. 14), and had an end fission power rate between 25-50 megawatts. The transient model showed that the molten fuel salt temperature remains in a safe range during a fuel pump failure scenario with carbon dioxide as the gas coolant, with a brief temperature spike to about 1300 Kelvin, which is within the safe range for the molten salt reactor system.

In operation, the in-core printed circuit heat exchangers may be connected to multiple units in order to increase system efficiency and redundancy. In this regard, FIG. 17A depicts an example system 1700a in which three pool-type reactors are coupled to one another, a first reactor 1701, a second reactor 1701′ and a third reactor 1702″. The first reactor 1701 may be substantially analogous to the pool-type reactor 300a of FIG. 3A and include an in-core heat exchanger 1702, a reactor vessel 1704, a coolant outlet 1706, and a coolant inlet 1708. Similarly, the second reactor 1701′ may be substantially analogous to the pool-type reactor 300a of FIG. 3A and include an in-core heat exchanger 1702′, a reactor vessel 1704′, a coolant outlet 1706′, and a coolant inlet 1708′. Similarly, the third reactor 1701″ may be substantially analogous to the pool-type reactor 300a of FIG. 3A and include an in-core heat exchanger 1702″, a reactor vessel 1704″, a coolant outlet 1706″, and a coolant inlet 1708″. In the example of FIG. 17A, each of the coolant outlets 1706, 1706′, 1706″ may feed a common electrical conversion unit 1710. The electrical conversion unit 1710 may be substantially any component or system configured to generate electricity from heat, such as a turbine, as described herein at FIG. 11. The electrical conversion unit 1710 may deliver the coolant to an ultimate heat sink 1712, such as the atmosphere or a collection tank for scrubbing the gas before releasing to atmosphere, and as described in greater detail in relation to FIG. 11. Further, the ultimate heat sink may deliver the coolant to a compressor 1714 at which the coolant may be repressurized for reentry into respective ones of the reactors 1701, 1701′, 1701″. In some cases, the compressor 1714 may operate as a component of a Brayton cycle such as with input from the electrical conversion unit 1710 or turbine 1710.

With reference to FIG. 17B, the multiple reactors of a “loop-type” configuration and coupled to one another in order to collectively provide heat for electrical conversion. For example, a first reactor 1751, a second reactor 1751′, and a second reactor 1751″ is shown. Each of the reactors 1751, 1751′, 1751″ may be substantially analogous to the loop-type reactors shown in relation to FIGS. 1A and 1B. In this regard, the first reactor 1751 is shown as including an in-core heat exchanger 1752, a reactor vessel 1754, a coolant outlet 1756, a coolant inlet 1758, a molten salt fuel inlet 1760, and a molten salt fuel outlet 1762. Further, the second reactor 1751′ is shown as including an in-core heat exchanger 1752′, a reactor vessel 1754′, a coolant outlet 1756′, a coolant inlet 1758′, a molten salt fuel inlet 1760′, and a molten salt fuel outlet 1762′. Further, the third reactor 1751″ is shown as including an in-core heat exchanger 1752″, a reactor vessel 1754″, a coolant outlet 1756″, a coolant inlet 1758″, a molten salt fuel inlet 1760″, and a molten salt fuel outlet 1762″. Each of the reactors 1751, 1751′, 1751″ is shown arranged along a common fuel loop 1753 such that each of the reactors shares a common circulation of fuel salt therebetween. FIG. 17B further shows each of the reactor 1751, 1751′, 1751″ as delivering coolant to a common electrical conversion unit 1764, which may operate with an ultimate heat sink 1766 and a compressor 1768 in a manner substantially analogous to that described in FIG. 17A.

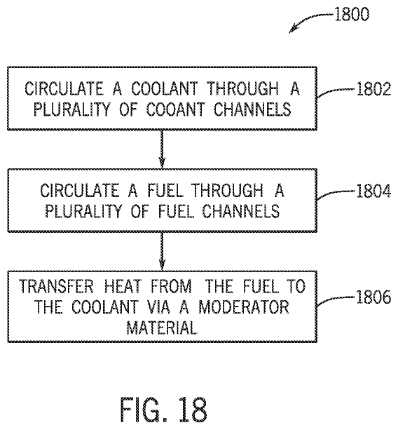

FIG. 18 depicts a flow diagram 1800 of an example method of removing heat from a molten salt reactor system. At operation 1802, a coolant is circulated through a plurality of flow channels. For example, and with reference to FIGS. 4 and 5, a coolant is circulated through the plurality of coolant channels 444. The coolant may be a molten salt, a gas, and/or other coolant as described herein. The coolant may be delivered, in one example, to the heat exchanger 400 via the coolant distributor 420a, and upon exit from the heat exchanger 400, be delivered to the coolant distributor 420b at which the coolant is formed into a single coolant exit flow.

At operation 1804, a fuel is circulated through a plurality of fuel channels. For example, and with reference to FIGS. 4 and 5, a fuel is circulated through the plurality of fuel channels 442. The fuel may be a molten salt including fissile material therein. The fuel may be delivered, in one example, to the heat exchanger 400 via the fuel distributor 410a, and upon exit from the heat exchanger 400, be delivered to the fuel distributor 410b at which the coolant is formed into a single fuel exit flow.

At operation 1806, heat is transferred from the fuel to the coolant via a moderator material. For example, and with reference to FIGS. 4 and 5, the moderator material 403 of the heat exchanger 400 may operate to transfer heat from the fuel salt of the plurality of fuel channels 442 to the coolant of the plurality of coolant channel 442. The moderator material 403 may further serve to control or cause fission reactions in the fuel salt flowing therethrough.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. An in-core printed circuit heat exchanger comprising
a heat exchange array formed from a moderator material and defining a plurality of fuel channels and a plurality of coolant channels therethrough, the plurality of coolant channels being fluidically isolated from the plurality of fuel channels;
a pair of fuel distributors coupled with opposing ends of the plurality of fuel channels and configured to provide the fuel to each of the plurality of fuel channels, and to correspondingly collect the fuel from each of the plurality of fuel channels and combine the fuel into a single fuel exit flow; and
a pair of coolant distributors coupled with opposing ends of the plurality of coolant channels and configured to provide the coolant to each of the plurality of coolant channels, and to correspondingly collect the coolant from each of the plurality of coolant channels and combine the coolant into a single coolant exit flow,
wherein the in-core printed circuit heat exchanger is configured to permit the fuel to undergo fission reactions therein.

2. The heat exchanger of claim 1, wherein the plurality of fuel channels and the plurality of coolant channels cooperate to establish
a cross flow of the fuel relative to the coolant,
a parallel flow of the fuel relative to the coolant, or
an opposing flow of the fuel relative to the coolant.

3. The heat exchanger of claim 1, wherein the moderator material defines
the plurality of fuel channel across a first stack of heat exchange layers, and
the plurality of coolant channels across a second stack of heat exchange layers interposed with the layers of the first stack of heat exchange layers.

4. The heat exchanger of claim 3, wherein the first stack of heat exchange layers and the second stack of heat exchange layers are, collectively, portions of an integrally constructed, one-piece structure.

5. The heat exchanger of claim 1, wherein channels of one or both of the plurality of fuel channels or the plurality of coolant channels establishes a tortuous flow path through the moderator material.

6. The heat exchanger of claim 5, wherein channels of one or both of the plurality of fuel channels or the plurality of coolant channels comprises a series of baffle structures to promote the tortuous flow path.

7. The heat exchanger of claim 1, wherein the pair of fuel distributors and the pair of coolant distributors comprise neutron reflector material.

8. The heat exchanger of claim 1, wherein the plurality of coolant channels is configured to receive a high temperature coolant comprising a supercritical CO₂, air, nitrogen, a helium, a molten salt, or a liquid metal.

9. The heat exchanger of claim 1, wherein
the heat exchange array, the pair of fuel distributors, and the pair of coolant distributors are arrangeable within a reactor vessel of an integral nuclear reactor system that permits the closed loop circulation of fuel therein,
the pair of fuel distributors each include an opening fluidly coupled with the fuel of the integral nuclear reactor,
the pair of coolant distributors is each coupled with a corresponding pair of coolant pipe legs that define a cold leg of the coolant flowing into a first distributor of the pair of coolant distributors, and a hot leg of the coolant flowing from a second distributor of the pair of coolant distributors, and
the pair of coolant distributors and the pair of coolant pipe legs maintain a fluidic isolation of the coolant from the fuel of the reactor vessel.

10. A molten salt reactor system comprising
an in-core printed circuit heat exchanger comprising a heat exchange array formed from a moderator material and defining a plurality of fuel channels and a plurality of coolant channels therethrough, the plurality of coolant channels being fluidically isolated from the plurality of fuel channels;
a coolant circulation system configured to provide a continuous circulation of a reduced temperature coolant to each of the plurality of coolant channels, and to receive a continuous circulation of an elevated temperature coolant from each of the plurality coolant channels; and
a fuel circulation system configured to provide a continuous circulation of an elevated temperature fuel to each of the plurality of fuel channels, and to receive a continuous circulation of a reduced temperature fuel from each of the plurality of fuel channels,
wherein the in-core printed circuit heat exchanger is configured to
permit the fuel to undergo fission reactions therein, and
transfer heat from the elevated temperature fuel to the reduced temperature coolant via the moderator material.

11. The system of claim 10, wherein
the coolant circulation system comprises a coolant system heat exchanger configured to transition the coolant from the elevated temperature coolant to the reduced temperature coolant for continuous circulation with the plurality of coolant channels of the in-core printed circuit heat exchanger, and
the fuel circulation system comprises a circulation driver configured to continuously provide fuel to the plurality of fuel channels.

12. The system of claim 11, wherein
the coolant comprises a gas, and
the coolant circulation system further comprises a turbine and a compressor arranged along a circulation path of the coolant with the plurality of coolant channels and the coolant system heat exchanger.

13. The system of claim 12, wherein
the turbine is configured to perform work from the elevated temperature coolant, said work being used to drive the compressor,
the compressor is configured to maintain a pressure of the coolant along the circulation path on being driven by the turbine, and
the coolant system heat exchanger is configured to reduce a temperature of the coolant exiting the turbine prior to said coolant being recirculated along the circulation path to the compressor and plurality of coolant channels of the in-core printed circuit heat exchanger.

14. The system of claim 11, wherein
the molten salt reactor system comprises an integral reactor vessel for the closed loop circulation of fuel therein,
the in-core printed circuit heat exchanger is arranged substantially within the integral reactor vessel with the plurality of fuel channels arranged along a circulation path of the fuel within the integral reactor vessel,
the in-core printed circuit heat exchanger further comprises a pair of coolant pipe legs that define a cold leg of the coolant for flowing the coolant into each channel of the plurality of coolant channels, and hot leg of the coolant for flowing the coolant from each channel of the plurality of coolant channels, and
the heat exchanger array cooperating with the pair of coolant pipe legs and the integral reactor vessel to maintain a fluidic isolation of the coolant from the fuel of the integral reactor vessel.

15. The system of claim 10, wherein
the in-core printed circuit heat exchanger is one of a plurality of in-core printed circuit heat exchangers, and
each plurality of coolant channels of the plurality of in-core printed circuit heat exchangers is fluidically coupled with the coolant circulation system.

16. A method of removing heat from a molten salt reactor system, the method comprising
circulating a coolant through a plurality of coolant channels formed through a moderator material;
circulating a fuel through a plurality of fuel channels formed through the moderator material, the plurality of fuel channels being fluidically isolated from the plurality of coolant channels; and
transferring heat from the fuel of the plurality of fuel channels to the coolant of the plurality of coolant channels via the moderator material,
wherein the fuel undergoes fission reactions within the plurality of fuel channels.

17. The method of claim 16, wherein circulating the coolant further comprises circulating the coolant along a continuous circulation path including a turbine, a coolant system heat exchanger, and a compressor.

18. The method of claim 17, further comprising
performing work, by the turbine, using an elevated temperature form of the coolant,
driving the compressor and generating electricity with the work performed by the turbine, and
maintaining, using the compressor, a pressure of the coolant along the circulation path of the coolant.

19. The method of claim 18, further comprising removing, using the coolant system heat exchanger, heat from the coolant prior to the coolant entering the compressor.

20. The method of claim 16, wherein circulating the fuel further comprises circulating the fuel along a circulation path of the fuel that is fully contained with a reactor vessel of an integral nuclear reactor system.
